(19) United States
(12) Patent Application Publication
(10) Pub. No.: US 2016/0338536 A1
(43) Pub. Date: Nov. 24, 2016

(54) BARBECUE GRILL COMPRISING A HEIGHT-ADJUSTABLE COOKING GRILL

(71) Applicant: TEPRO Garten GmbH, Roedermark (DE)

(72) Inventor: Carsten Witsch, Aachen (DE)

(21) Appl. No.: 15/156,516

(22) Filed: May 17, 2016

(30) Foreign Application Priority Data
May 19, 2015 (EP) 15168070.9

(51) Int. Cl. A47J 37/07

(52) U.S. Cl. CPC A47J 37/0786; A47J 2037/0795

(57) ABSTRACT

A barbecue grill (1) includes a housing (2) for receiving the charcoal and a plurality of functional parts (4) fastened to the housing (2) on an inner side (3) of the housing (2). Each functional part (4) has a plurality of bearing surfaces (6), onto which a cooking grid (5) is able to be positioned. The cooking grid (5) is positioned on corresponding bearing surfaces (6) of the functional parts (4) depending on the orientation of said cooking grid (5) at variable distances from the charcoal. Each functional part (4) forms bearing surfaces (6) arranged offset relative to one another vertically and in the peripheral direction of the housing (2).

### CROSS-REFERENCE TO RELATED APPLICATIONS

The instant application claims the priority date of May 19, 2015, the filing date of the European patent application EP 15168070.9.

### BACKGROUND OF THE INVENTION

The present invention relates to a barbecue grill comprising a housing for receiving the charcoal and a plurality of functional parts fastened to the housing on an inner side of the housing, wherein each functional part has a plurality of bearing surfaces onto which a cooking grid is able to be positioned, wherein the cooking grid is positioned on corresponding bearing surfaces of the functional parts depending on the orientation of the cooking grid at variable distances from the charcoal.

A barbecue grill is disclosed, for example, in U.S. Pat. No. 6,318,356 B1. A shaped part formed from a strip-shaped metal is arranged on the inner side of the housing, said shaped part being fastened by a central portion to the housing. A charcoal grid is able to be positioned onto the inwardly bent lower end of the shaped part, whilst the cooking grid is able to be positioned onto the inwardly bent upper end of the shaped part. The spacing between the cooking grid and the charcoal grid is not able to be altered, so that during the barbeque the temperature acting on the food to be grilled arranged on the cooking grid is not able to be rapidly changed. An alteration to the temperature may only take place indirectly by the air supply being altered by a ventilation device arranged on the base of the housing.

A cooking grid with the features cited in the introduction is disclosed in U.S. Pat. No. 3,664,322, wherein the cooking grid disclosed therein may be arranged by orientation in different directions and namely at different heights, but to this end the cooking grid has on its circumference constricted portions which engage at different depths and which are costly to produce.

### SUMMARY OF THE INVENTION

It is, therefore, the object of the present invention to solve at least partially the problems set forth with reference to the prior art and, in particular, to provide a barbecue grill in which the heat acting on the food to be grilled may be rapidly and easily altered and which is able to be produced in a more simple manner.

The object is achieved, in particular, by a barbecue grill having the aforementioned features, wherein each functional part forms bearing surfaces arranged offset relative to one another vertically and in the peripheral direction of the housing in such a way, that the cooking grid is able to be positioned at variable distances from the charcoal on corresponding bearing surfaces of the functional parts depending on the orientation of said cooking grid.

It is thus provided, in particular, that the cooking grid and the functional parts are configured such that the cooking grid is able to be positioned onto the functional parts with variable spacing from a base of the housing and/or from a charcoal grid arranged in the housing. This is achieved by the plurality of bearing surfaces formed on each functional part being offset vertically and horizontally to one another. In order to alter the spacing between the cooking grid and the charcoal, the cooking grid has to be lifted away from the functional parts and rotated in its plane sufficiently far that it is able to be repositioned on different bearing surfaces of the functional parts which correspond to one another. Handles may be attached to the cooking grid, the cooking grid being able to be lifted up and rotated thereby. Alternatively it could be provided that releasable handles might be attached to the cooking grid for lifting away the cooking grid. By means of the functional parts, a simple adjustability of the spacing of the cooking grid relative to the charcoal may be advantageously achieved.

“Barbecue grill” is understood, in particular, as such grills which have a circular cross section in a horizontal plane in which the cooking grid is arranged. It is, therefore, preferred, but indispensable for the invention, that the housing below the plane of the cooking grid and the cover which is able to be positioned on the housing are spherical. It is sufficient if the cross section of the housing in the plane of the cooking grid is a circular cross section.

The bearing surfaces are, in particular, formed on an upwardly oriented front face of the functional part, so that after alignment with an exclusively vertical movement the cooking grid is able to be positioned onto the bearing surfaces. The functional parts arranged on the inner side of the housing are preferably all of identical configuration and fastened at the same height to the housing, so that the corresponding bearing surfaces on the functional parts, onto which the cooking grid is positioned at a specific distance from the charcoal, correspond to one another. With the alignment of the cooking grid, in particular, is understood as the alignment thereof in the plane of the cooking grid relative to the housing.

With the increasing popularity of grilling, a plurality of accessories have also been developed by which the food to be grilled may be prepared in different ways. These accessories have to be fastened in a suitable manner to a barbecue grill. According to a further individual feature of the invention, therefore, independently of the bearing surfaces formed on the functional parts it is proposed that at least one recess is formed on an upper side of a functional part for the releasable fastening of an accessory. A set of accessories could consist, for example, of two bars which extend substantially parallel to one another on the edge of the grill, in particular above the cooking grid, and onto which skewers comprising food to be grilled may be positioned. A further accessory could be, for example, an auxiliary cooking grid which is arranged above the main cooking grid at a substantially greater distance. The auxiliary cooking grid, in particular, has a different shape and size from the main cooking grid. For example, the auxiliary cooking grid has a semi-circular region for food to be grilled, fastening bars extending downwardly therefrom to the recesses in the functional parts. For example, already grilled food could be placed on this auxiliary cooking grid to be kept hot. Additionally, an accessory could be a bar extending outwardly around the housing, on which utensils such as for example grill tongs may be suspended. In particular, by combining the bearing surfaces and the recesses, the functional part combines a plurality of functions for fastening the cooking grid and accessories.

In particular, two bores are formed on the upper side of the functional part, said bores being preferably provided such that accessories are fastened thereto, said accessories extending in a state inserted into one respective bore of different functional parts above the cooking grid. Thus, for example, bars inserted at their ends into one respective bore of a functional part may be fastened to the grill, skewers extending transversely thereto being placed thereon.

Moreover, it may be provided that an elongated slot is formed on the upper face of the functional part, preferably for fastening an accessory extending from the functional parts outwardly around the housing from one functional part to an adjacent functional part. Therefore, an accessory extending outwardly around the housing may be suspended in the slot of two adjacent functional parts, grill utensils being able to be suspended thereon, for example.

Preferably, the bearing surfaces of each functional part are arranged as a whole in a stepped manner. Adjacent bearing surfaces of a functional part are, therefore, arranged in the peripheral direction of the housing and/or horizontally immediately adjacent to one another or only with a small distance from one another, wherein the adjacent bearing surfaces are offset vertically from one another. By the stepped arrangement it is achieved that, by rotating the cooking grid in one direction, the distance from the charcoal may be reduced and, by rotating in the opposing direction and subsequent bearing on bearing surfaces, the distance from the charcoal may be increased.

So that the cooking grid adopts a predetermined position when positioned on corresponding bearing surfaces, it is provided that each bearing surface has an uneven path with a low point. The bearing surfaces have, for example, a parabola-shaped path in one cutting plane, wherein the cooking grid automatically reaches the corresponding low points of the bearing surfaces when positioned on the bearing surfaces.

Preferably, it may be provided that each bearing surface is defined laterally by a stop surface. So that the cooking grid in such an embodiment is able to be positioned on other bearing surfaces, the cooking grid initially has to be lifted away beyond the stop surfaces and may only then be rotated. As a result, in particular, inadvertent rotation of the cooking grid bearing against the bearing surfaces is prevented.

Preferably, the cooking grid comprises bearing elements which protrude over a region for food to be grilled of the cooking grid and by which the cooking grid bears on the corresponding bearing surfaces of the functional parts. Whilst in barbecue grills without a height adjustment of the cooking grid the region for food to be grilled of the cooking grid is able to touch directly a side wall of the housing, according to one embodiment of the invention the region for food to be grilled should have a peripheral aperture relative to the housing, the functional parts being fastened to the housing in said aperture. The cooking grid protrudes with the bearing elements into this aperture and is positioned with the bearing elements onto the bearing surfaces of the functional part. In particular, the bearing elements are formed by bars of the cooking grid protruding over the region for food to be grilled.

In one embodiment, it is provided that the functional parts are fastened to the grill by a fastening element protruding to the outer side of the housing, and on the outer side of the housing a support is fastened by the fastening element to the housing. The fastening element is, in particular, a screw securing the functional part to the inner side of the housing, wherein the fastening element at the same time serves for fastening the support onto the outer side of the housing. The support is, in particular, a mounting by which the housing may be fastened to a grill trolley.

### BRIEF DESCRIPTION OF THE DRAWINGS

The invention and the technical field are described hereinafter with reference to the figures, wherein reference should be made to the fact that the figures show a preferred embodiment of the invention. In the drawings, schematically

FIG. 1: shows a barbecue grill with a cooking grid in a first position;

FIG. 2: shows the barbecue grill with the cooking grid in a second position;

FIG. 3: shows a functional part;

FIG. 4: shows the barbecue grill with a first accessory;

FIG. 5: shows the barbecue grill with a second accessory; and

FIG. 6: shows the barbecue grill with a third accessory.

### DETAILED DESCRIPTION OF THE PREFERRED EMBODIMENTS

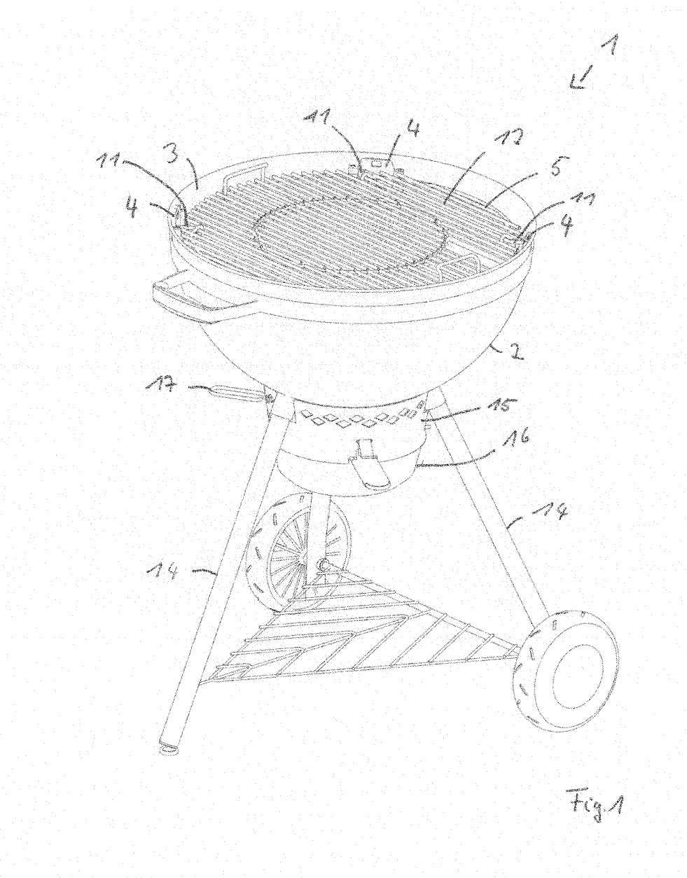

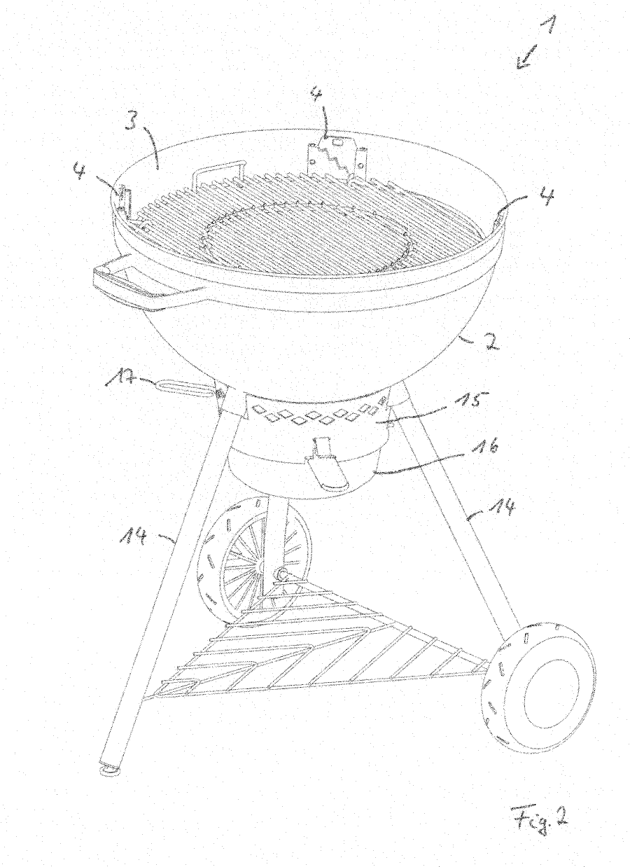

The barbecue grill 1 shown in FIGS. 1 and 2 comprises a housing 2, three legs 14 being attached thereto on an outer face at the bottom. Additionally, a retaining ring 15 is arranged between the legs 14, an ash pan 16 being able to be fastened thereto. An actuating handle 17 protrudes through the retaining ring 15, a device for ventilation and ash removal of the housing 2 being able to be operated thereby.

Four functional parts 4 are fastened onto an inner side 3 of the housing 2, a cooking grid 5 being placed thereon. The cooking grid 5 has a circular region for food to be grilled 12 consisting of a plurality of bars, wherein bearing elements 11 protrude over the circular region for food to be grilled 12. The bearing elements 11 are formed by the bars correspondingly protruding in a bent manner over the circular region for food to be grilled 12. The cooking grid 5 bears on the functional parts 4 with the bearing elements 11.

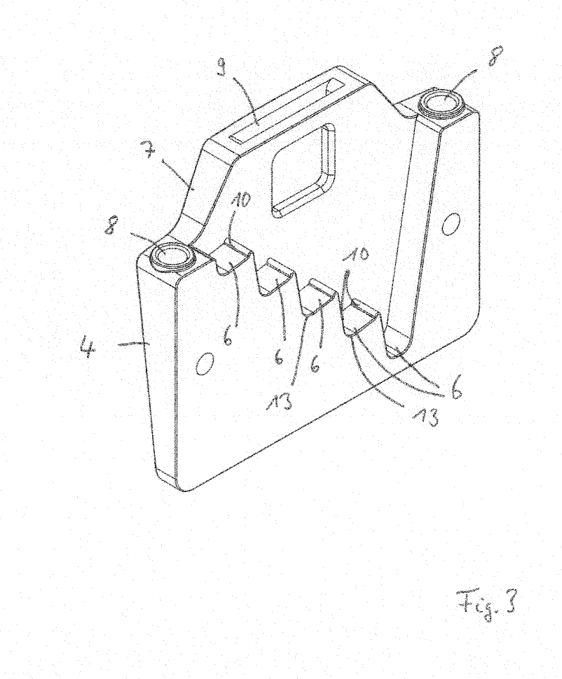

A functional part 4 is shown in FIG. 3. The functional part 4 has a plurality of bearing surfaces 6 which are arranged on the functional part 4 in a stepped manner. Each bearing surface 6 has a low point 13 and is defined laterally by stop surfaces 10. Two bores 8 and a slot 9 are formed on an upper side 7 of the functional part 4.

The four functional parts 4 are fastened onto the inner side 3 of the housing 2 such that the cooking grid 5 with its four bearing elements 11 is positioned in each case on a bearing surface 6 of the four functional parts 4, which thus correspond with one another. If the cooking grid 5 bears on the respective uppermost bearing surfaces 6, the distance of the cooking grid 5 from a charcoal grid arranged below in the housing 2 is thus at the greatest (see FIG. 1). The cooking grid 5 may be realigned by lifting away from the uppermost bearing surfaces 6 and by rotating in its plane, and positioned on corresponding bearing surfaces 6 arranged further below, so that the distance between the cooking grid 5 and the charcoal grid may be reduced, whereby the temperature acting on the food to be grilled may be rapidly altered (see FIG. 2). By the configuration of the low points 13 the cooking grid 5 regularly reaches a position predetermined by the low points 13.

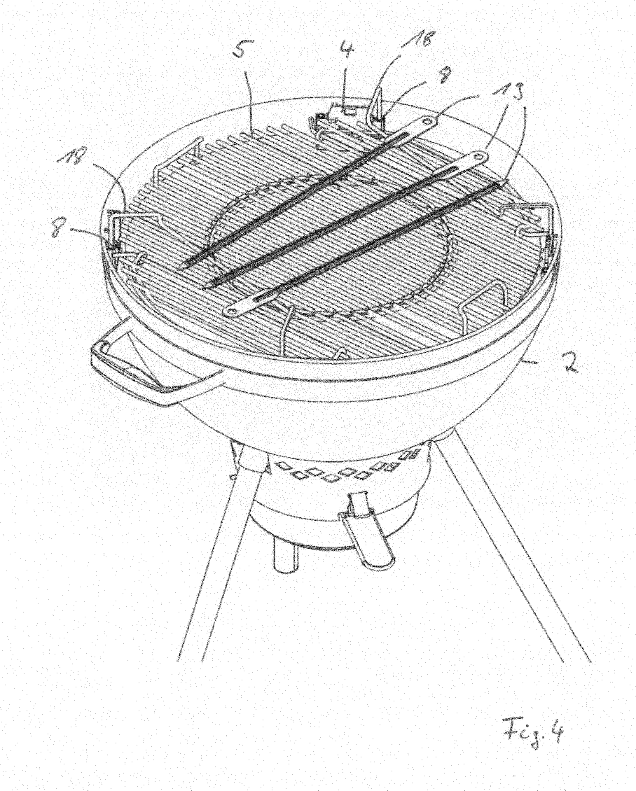

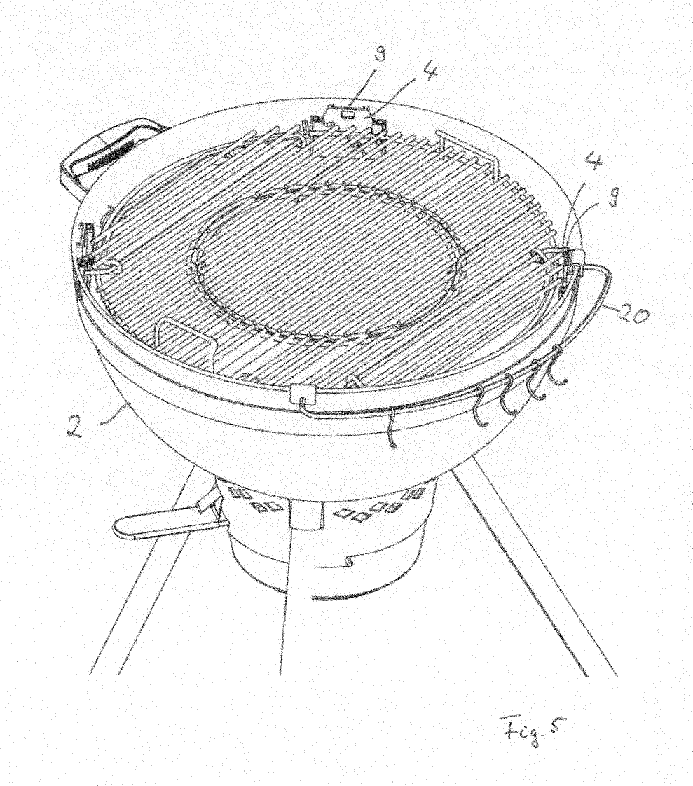

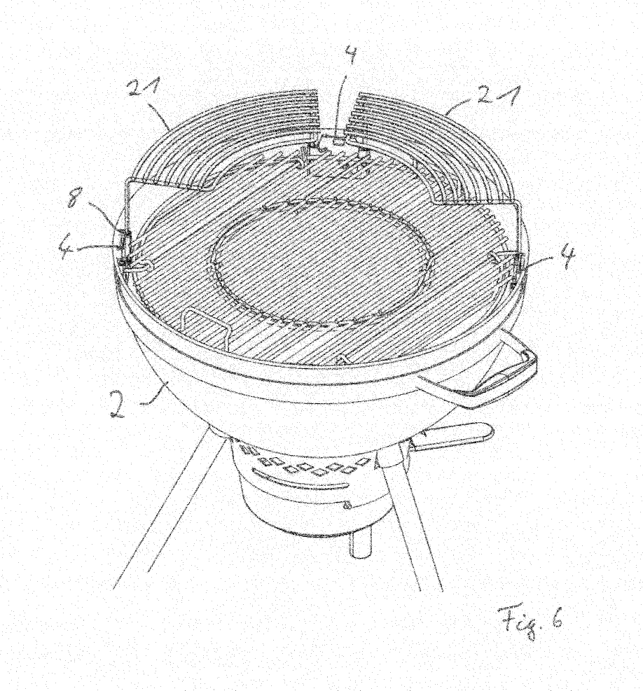

Accessories for the barbecue grill 1 may be inserted into the bores 8 and the slot 9. Thus, for example, bars 18 extending over the region for food to be grilled 12 may be inserted into bores 8 of adjacent functional parts 4, onto which in turn skewers 19 with food to be grilled may be positioned (see FIG. 4). Preferably, a fastening rod 20 is inserted into the slot 9, said fastening rod 20 extending outwardly from a functional part 4 and along the housing 2 to an adjacent functional part 4. For example, grill utensils may be suspended on this fastening rod 20 (see FIG. 5). An accessory shown in FIG. 6 is an auxiliary cooking grid 21 which is inserted into bores 8 of adjacent functional parts 4. The region for food to be grilled of the auxiliary cooking grid 21 has a semi-circular shape and may serve for keeping grilled food hot.

The specification incorporates by reference the disclosure of EP 15168070.9, filed May 19, 2015.

The present invention is, of course, in no way restricted to the specific disclosure of the specification and drawings, but also encompasses any modifications within the scope of the appended claims.

### LIST OF REFERENCE NUMERALS

1 Barbecue grill
2 Housing
3 Inner side
4 Functional part
5 cooking grid
6 Bearing surface
7 Upper side
8 Bore
9 Slot
10 Stop surfaces
11 Bearing elements
12 Region for food to be grilled
13 Low point
14 Leg
15 Retaining ring
16 Ash pan
17 Actuating handle
18 Bar
19 Skewer
20 Fastening rod
21 Auxiliary cooking grid

1. A barbecue grill (1) comprising:
housing (2) for receiving charcoal; and
a plurality of functional parts (4) fastened to the housing (2) on an inner side (3) of the housing (2), wherein each functional part (4) has a plurality of bearing surfaces (6);
a cooking grid (5), wherein the cooking grid (5) is positioned on corresponding bearing surfaces (6) of the functional parts (4) depending on the orientation of said cooking grid (5) at variable distances from the charcoal, wherein each functional part (4) forms bearing surfaces (6) arranged offset relative to one another vertically and in the peripheral direction of the housing (2).

2. The barbecue grill (1) according to claim 1, wherein at least one recess (8, 9) is formed on an upper side (7) of a functional part (4) for the releasable fastening of an accessory (18, 19, 20, 21).

3. The barbecue grill (1) according to claim 2, wherein two bores (8) are formed on the upper side (7) of the functional part (4).

4. The barbecue grill (11) according to claim 3, wherein said two bores (8) are configured for fastening an accessory (18, 21) that extends over the cooking grid (5) in a state inserted into respective bores (8) of different functional parts (4).

5. The barbecue grill (1) according to claim 2, wherein an elongated slot (9) is formed on the upper side (7) of the functional part (4).

6. The barbecue grill (1) according to claim 5 wherein said elongated slot is configured for fastening an accessory (20) extending from the functional parts (4) outwardly around the housing (2) from one functional part (4) to an adjacent functional part (4).

7. The barbecue grill (1) according to claim 1, wherein the bearing surfaces (6) of each functional part (4) are arranged as a whole in a stepped manner.

8. The barbecue grill (1) according to claim 1, wherein each bearing surface (6) has an uneven path with a low point (13).

9. The barbecue grill (1) according to claim 1, wherein each bearing surface (6) is defined laterally by a stop surface (10).

10. The barbecue grill (1) according to claim 1, wherein the cooking grid (5) comprises bearing elements (11) which protrude over a region for food to be grilled (12) of the cooking grid (5) and with which the cooking grid (5) bears on the corresponding bearing surfaces (6) of the functional parts (4).

11. The barbecue grill (1) according to claim 1, wherein the functional parts (4) are fastened to the barbecue grill (1) by a fastening element protruding to the outer side of the housing (2), and wherein a support is fastened by the fastening element to the housing (2) on the outer side of the housing (2).
